(19) United States
(12) Patent Application Publication
(10) Pub. No.: US 2025/0297668 A1
(43) Pub. Date: Sep. 25, 2025

(54) FLUID-FILLED VIBRATION DAMPING DEVICE AND MANUFACTURING METHOD THEREOF

(71) Applicant: Sumitomo Riko Company Limited, Aichi (JP)

(72) Inventors: Hiroyuki Kashihara, Aichi (JP); Satoshi Umemura, Aichi (JP)

(73) Assignee: Sumitomo Riko Company Limited, Aichi (JP)

(21) Appl. No.: 19/230,120

(22) Filed: Jun. 6, 2025

Related U.S. Application Data
(63) Continuation of application No. PCT/JP2024/007781, filed on Mar. 1, 2024.

(30) Foreign Application Priority Data
Mar. 8, 2023 (JP) 2023-035171

(51) Int. Cl. F16F 13/18; F16F 13/10

(52) U.S. Cl. CPC F16F 13/18; F16F 13/103; F16F 2238/04

(57) ABSTRACT

In a fluid-filled vibration damping device in which a pressure receiving chamber and an equilibrium chamber including a flexible film in a wall are communicated by a fluid passage, a bottomed tubular mounting bracket covering the flexible film includes a notch window that partially opens in a circumferential direction at an outer peripheral corner. The notch window includes an outward punched window formed by punching from the inside toward the outside in an oblique direction in a region extending across a bottom wall and a peripheral wall of the mounting bracket. A mounting plate of a bracket leg fixed to the mounting bracket enters from the outside to the inside of the mounting bracket through the outward punched window, and an outer fixing bolt for fixing to a vibration damping target member is mounted on the mounting plate and located within the outward punched window.

### CROSS-REFERENCE TO RELATED APPLICATION

This application is a continuation of PCT International Application No. PCT/JP2024/007781, filed on Mar. 1, 2024, which claims priority under 35 U.S.C § 119(a) to Japanese Patent Application No. 2023-035171, filed on Mar. 8, 2023. Each of the above application(s) is hereby expressly incorporated by reference, in its entirety, into the present application.

### BACKGROUND

### Technical Field

The present disclosure relates to a fluid-filled vibration damping device applied to an engine mount or the like of an automobile.

### Related Art

Conventionally, as one type of vibration damping device applied to engine mounts or the like of automobiles, a fluid-filled vibration damping device is known which utilizes vibration damping effects of the flow action of fluid sealed inside or the like. The fluid-filled vibration damping device, as shown in Japanese Patent Laid-Open No. 2007-182930 (Patent Document 1), has a structure in which a pressure receiving chamber having a main body rubber elastomer in a wall and an equilibrium chamber having a flexible film in a wall are in communication with each other through a fluid passage.

In the fluid-filled vibration damping device of Patent Document 1, a bottomed tubular member (bottom fitting) that covers the flexible film is provided for the purpose of protecting the flexible film or the like. This member covering the flexible film is utilized as a mounting bracket that constitutes a mounting structure in the fluid-filled vibration damping device with respect to a vibration damping target member such as a vehicle body, and constitutes the mounting structure by having a fixing bolt provided on a bottom wall.

However, in the mounting structure in which the fixing bolt is provided on the bottom wall, when a fixing position of the fluid-filled vibration damping device on the vehicle side is set at a position outside the bottom wall of the mounting bracket, it is difficult to constitute the mounting structure of the fluid-filled vibration damping device with respect to the vehicle by means of the mounting bracket, and the degree of freedom in setting the fixing position of the fluid-filled vibration damping device in the vehicle is limited. In particular, it is difficult to accommodate a case where the fixing bolt needs to be arranged to be located on an extension of a peripheral wall of the mounting bracket.

### SUMMARY

According to one aspect of the present disclosure, a fluid-filled vibration damping device includes: a pressure receiving chamber, including a main body rubber elastomer in a wall, the main body rubber elastomer being elastically deformed upon receiving a vibration; an equilibrium chamber, including a flexible film in a wall; a fluid passage, communicating the pressure receiving chamber and the equilibrium chamber with each other; a mounting bracket of a bottomed tubular shape, covering the flexible film; a notch window, partially opening in a circumferential direction at an outer peripheral corner on a bottom wall side of the mounting bracket, including an outward punched window formed by punching from the inside toward the outside in an oblique direction in a region extending across both the bottom wall and a peripheral wall of the mounting bracket; a bracket leg, firmly fixed to the mounting bracket, provided with a mounting plate that enters from the outside to the inside of the mounting bracket through the outward punched window of the mounting bracket; and an outer fixing bolt, for fixing the mounting bracket to a vibration damping target member, mounted on the mounting plate and located within the outward punched window.

According to another aspect of the present disclosure, a manufacturing method of a fluid-filled vibration damping device is provided in which the fluid-filled vibration damping device includes: a pressure receiving chamber, including a main body rubber elastomer in a wall, the main body rubber elastomer being elastically deformed upon receiving a vibration; an equilibrium chamber, including a flexible film in a wall; a fluid passage, communicating the pressure receiving chamber and the equilibrium chamber with each other; and a mounting bracket of a bottomed tubular shape, covering the flexible film. The manufacturing method includes the following processes in manufacturing the fluid-filled vibration damping device. By performing punching from the inside toward the outside in an oblique direction on an outer peripheral corner on a bottom wall side extending across both the bottom wall and a peripheral wall of the mounting bracket, an outward punched window of a notch shape is formed that partially opens in a circumferential direction at the outer peripheral corner of the mounting bracket. A bracket leg is firmly fixed to the mounting bracket, the bracket leg including a mounting plate that enters from the outside to the inside of the mounting bracket through the outward punched window of the mounting bracket.

### BRIEF DESCRIPTION OF THE DRAWINGS

FIG. 1 is a perspective view showing an engine mount as a first embodiment of the present disclosure.

FIG. 2 is a front view of the engine mount shown in FIG. 1.

FIG. 3 is a plan view of the engine mount shown in FIG. 2.

FIG. 4 is a cross-sectional view taken along IV-IV in FIG. 3.

FIG. 5 is a front view showing a bracket fitting constituting the engine mount of FIG. 1.

FIG. 6 is a plan view of the bracket fitting shown in FIG. 5.

FIG. 7 is a bottom view of the bracket fitting shown in FIG. 5.

FIG. 8 is a right side view of the bracket fitting shown in FIG. 5.

FIG. 9 is a perspective view of a mounting bracket constituting the bracket fitting shown in FIG. 5.

FIG. 10 is a perspective view showing the mounting bracket of FIG. 9 from a different angle.

FIG. 11A is a cross-sectional view showing a manufacturing process of the mounting bracket of FIG. 9, showing a state before punching.

FIG. 11B is a cross-sectional view showing a manufacturing process of the mounting bracket of FIG. 9, showing a state during punching.

FIG. 11C is a cross-sectional view showing a manufacturing process of the mounting bracket of FIG. 9, showing a state after punching.

### DESCRIPTION OF THE EMBODIMENTS

The present disclosure provides a fluid-filled vibration damping device having a structure in which, while a member covering a flexible film is utilized as a mounting bracket for a vibration damping target member, a fixing position of the mounting bracket in the vibration damping target member can be set with a high degree of freedom.

The following describes preferred aspects for understanding the present disclosure. However, each aspect described below is described for illustrative purposes and may not only be appropriately combined with each other for adoption, but also multiple component elements described in each aspect can be recognized and adopted independently as much as possible, and can also be combined with any component elements described in other aspects as appropriate. Thereby, in the present disclosure, various alternative aspects can be realized without being limited to the aspects described below.

According to one aspect, a fluid-filled vibration damping device is provided in which a pressure receiving chamber including a main body rubber elastomer in a wall and an equilibrium chamber including a flexible film in a wall are communicated with each other by a fluid passage, the main body rubber elastomer being elastically deformed upon receiving a vibration. In the fluid-filled vibration damping device, a mounting bracket of a bottomed tubular shape is provided covering the flexible film; a notch window that partially opens in a circumferential direction at an outer peripheral corner on a bottom wall side of the mounting bracket includes an outward punched window formed by punching from the inside toward the outside in an oblique direction in a region extending across both the bottom wall and a peripheral wall of the mounting bracket; a bracket leg is firmly fixed to the mounting bracket, and a mounting plate provided on the bracket leg enters from the outside to the inside of the mounting bracket through the outward punched window of the mounting bracket; and an outer fixing bolt for fixing the mounting bracket to a vibration damping target member is mounted on the mounting plate, and the outer fixing bolt is located within the outward punched window.

According to the fluid-filled vibration damping device structured in accordance with the present aspect, the notch window is formed penetrating the outer peripheral corner of the mounting bracket, and the outer fixing bolt is mounted on the mounting plate of the bracket leg that enters from the outside to the inside through the notch window. Accordingly, even if a fastening point between the outer fixing bolt and the vibration damping target member is set at a position where the outer fixing bolt and the peripheral wall (outer peripheral corner) of the mounting bracket interfere with each other, by arranging the outer fixing bolt within the notch window, interference between the outer fixing bolt and the mounting bracket can be avoided. Thus, the position of the outer fixing bolt can be set over a relatively wide area, and the fixing position between the fluid-filled vibration damping device and the vibration damping target member can be set with a high degree of freedom.

By repeating trial manufacture and examination, the present inventor has discovered a new problem specific to a fluid-filled vibration damping device equipped with a mounting bracket including a notch window. That is, when the notch window is composed of an inward punched window formed by general punching from the outside toward the inside of the mounting bracket, burrs during punching are formed to protrude inward at an opening edge of the inward punched window. It has been newly discovered that, when such inward burrs are formed on the mounting bracket covering the flexible film, there may be cases where the flexible film contacts the burrs due to, for example, expansion of the flexible film during vibration input, and the flexible film may be damaged.

Accordingly, the notch window of the mounting bracket is composed of the outward punched window formed by punching from the inside toward the outside. Accordingly, the formation of burrs due to punching on the inside of the mounting bracket can be prevented, thereby preventing damage to the flexible film caused by contact with burrs. Moreover, an inner opening edge of the outward punched window is likely to have an edge crushed by pressing of a punch for punching during the punching and be chamfered. Thus, the formation of an edge protruding inward at the inner opening edge of the outward punched window can be avoided. Even if the flexible film contacts the inner opening edge of the outward punched window, damage to the flexible film is relatively easy to prevent.

Since the outward punched window is formed by punching in a region extending across both the bottom wall and the peripheral wall of the mounting bracket in an oblique direction, the outward punched window allowing the outer fixing bolt to be arranged therein can be formed by punching once.

According to another aspect, in the fluid-filled vibration damping device as described above, a lower surface of the mounting plate is formed with a mounting surface that extends in the same plane as an outer surface of the bottom wall of the mounting bracket.

According to the fluid-filled vibration damping device structured in accordance with the present aspect, for example, the outer surface (lower surface) of the bottom wall and the lower surface of the mounting plate overlap in contact with the same plane of the vibration damping target member, and the mounting bracket and the mounting plate can be mounted on the vibration damping target member.

According to another aspect, in the fluid-filled vibration damping device as described above, a reinforcement plate overlaps from an inner surface and is firmly fixed to the bottom wall of the mounting bracket, and an inner fixing bolt for fixing the mounting bracket to the vibration damping target member is provided penetrating the reinforcement plate and the bottom wall.

According to the fluid-filled vibration damping device structured in accordance with the present aspect, by providing the inner fixing bolt in addition to the outer fixing bolt, the mounting bracket can be fixed to the vibration damping target member with relatively great strength. Moreover, even if a large load is input to the inner fixing bolt provided to penetrate the bottom wall of the mounting bracket and the reinforcement plate, deformation of the bottom wall can be prevented.

According to another aspect, in the fluid-filled vibration damping device as described above, the outward punched window is of an opening shape that curves smoothly without corners in a projection in a punching direction.

According to the fluid-filled vibration damping device structured in accordance with the present aspect, stress concentration during punching can be prevented, and damage to the mounting bracket during punching can be prevented.

According to another aspect, in a fluid-filled vibration damping device, a pressure receiving chamber including a main body rubber elastomer in a wall and an equilibrium chamber including a flexible film in a wall are communicated with each other by a fluid passage, the main body rubber elastomer being elastically deformed upon receiving a vibration, a mounting bracket of a bottomed tubular shape being provided covering the flexible film. In manufacturing the fluid-filled vibration damping device, the following processes (a) and (b) are performed. In process (a), by performing punching from the inside toward the outside in an oblique direction on an outer peripheral corner on a bottom wall side extending across both the bottom wall and a peripheral wall of the mounting bracket, an outward punched window of a notch shape is formed that partially opens in a circumferential direction at the outer peripheral corner of the mounting bracket. In process (b), a bracket leg is firmly fixed to the mounting bracket, the bracket leg including a mounting plate that enters from the outside to the inside of the mounting bracket through the outward punched window of the mounting bracket.

According to the manufacturing method of a fluid-filled vibration damping device in accordance with the present aspect, since the outward punched window of a notch shape is formed by punching the outer peripheral corner on the bottom wall side of the mounting bracket from the inside toward the outside, burrs due to punching are less likely to be formed on the inside of the mounting bracket, and post-processing such as deburring or chamfering with respect to the inner opening edge of the outward punched window can also be simplified.

By inserting the bracket leg including the mounting plate from the outside to the inside into the outward punched window formed by punching, and firmly fixing the bracket leg to the mounting bracket, the mounting plate can be arranged within the outward punched window.

Since the outward punched window is formed by punching in a region extending across both the bottom wall and the peripheral wall of the mounting bracket in an oblique direction, it is possible to form the outward punched window that penetrates both the bottom wall and the peripheral wall of the mounting bracket by punching once, and the number of processes can be reduced.

According to another aspect, in the manufacturing method of a fluid-filled vibration damping device as described above, a punch for punching contacts and punches both side edges separated on the bottom wall side and the peripheral wall side of the mounting bracket in advance of contacting and punching the outer peripheral corner between the bottom wall and the peripheral wall of the mounting bracket.

When the outer peripheral corner on the bottom wall side of the mounting bracket is punched in an oblique direction across both the bottom wall and the peripheral wall, the shape of the outward punched window is likely to be distorted due to deformation of the mounting bracket caused by pressing of the punch for punching. However, according to the manufacturing method of a fluid-filled vibration damping device in accordance with the present aspect, the outward punched window of a desired shape can be formed with high accuracy.

According to the present disclosure, while the member covering the flexible film is utilized as a mounting bracket for the vibration damping target member, the fixing position of the mounting bracket in the vibration damping target member can be set with a high degree of freedom.

The following describes embodiments of the present disclosure with reference to the drawings.

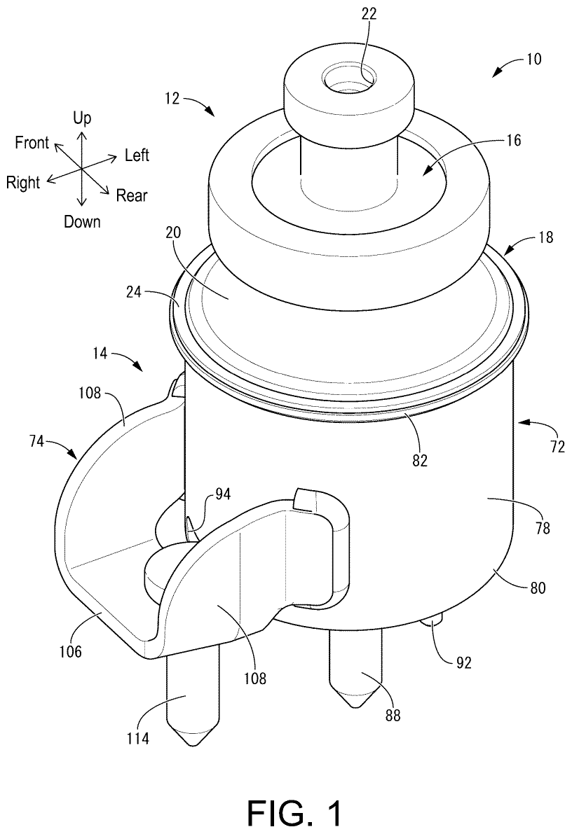

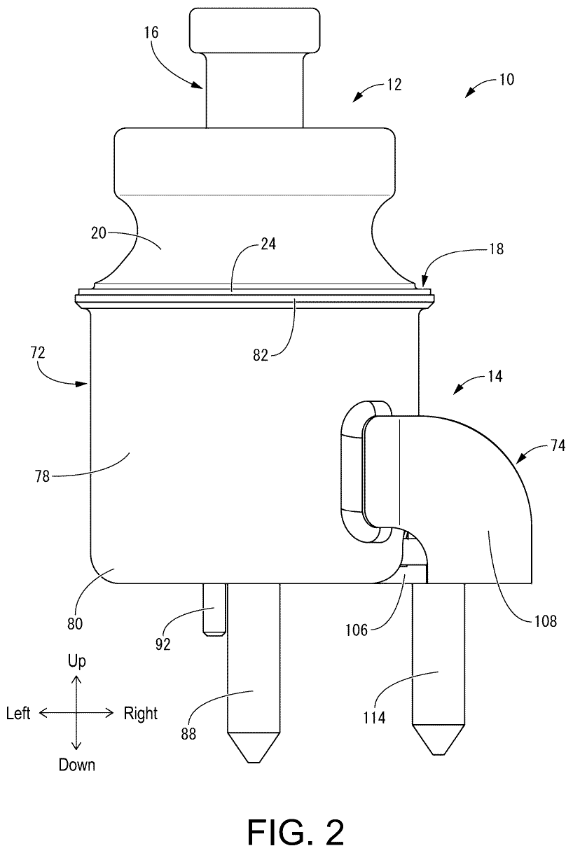

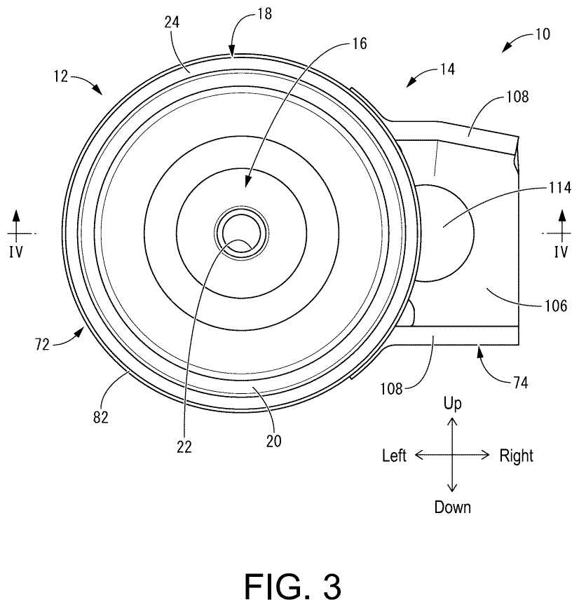

FIG. 1 to FIG. 4 show an engine mount 10 of an automobile as a first embodiment of a fluid-filled vibration damping device structured according to the present disclosure. The engine mount 10 has a structure in which a mounting bracket 14 is mounted on a mount body 12. Furthermore, the mount body 12 has a structure in which a first mounting member 16 and a second mounting member 18 are connected by a main body rubber elastomer 20. In the following description, in principle, the up-down direction refers to the up-down direction in FIG. 2, the front-rear direction refers to the up-down direction in FIG. 3, and the left-right direction refers to the left-right direction in FIG. 3, respectively.

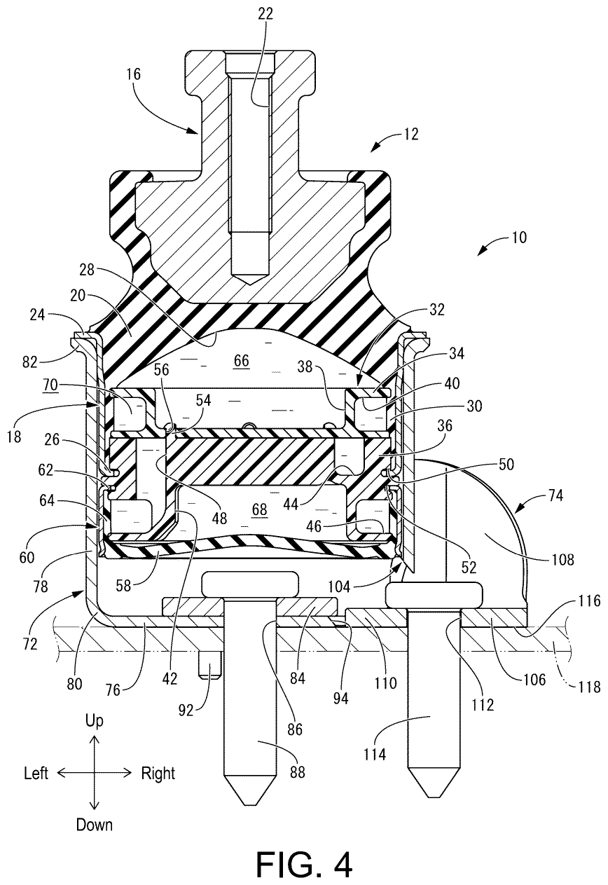

The first mounting member 16 is a rigid member made of metal or the like. As shown in FIG. 4, the first mounting member 16 has an overall stepped columnar shape with a lower part having a larger diameter than an upper part. The first mounting member 16 has a screw hole 22 formed to extend in the up-down direction along a central axis and opening at an upper surface.

The second mounting member 18 is a rigid member made of metal or the like, and is of a substantially cylindrical shape having a small thickness and a large diameter. The second mounting member 18 is provided with an outer flange 24 protruding toward an outer periphery at an upper end, as well as an inner flange 26 protruding toward an inner periphery at a lower end.

The first mounting member 16 is arranged above the second mounting member 18 on the same central axis, and the first mounting member 16 and second mounting member 18 are elastically connected by the main body rubber elastomer 20. The main body rubber elastomer 20 is of a substantially truncated cone shape having an outer peripheral surface reducing in diameter upward. In the main body rubber elastomer 20, the first mounting member 16 is firmly fixed to an upper end and the second mounting member 18 is firmly fixed to an outer peripheral surface of a lower end. The upper part of the first mounting member 16 that is smaller in diameter protrudes upward from the main body rubber elastomer 20, and the inner flange 26 of the second mounting member 18 is exposed below the main body rubber elastomer 20. The main body rubber elastomer 20 is formed as an integrally vulcanized molded product including the first mounting member 16 and the second mounting member 18. The first mounting member 16 and the second mounting member 18 are vulcanization-bonded during the molding of the main body rubber elastomer 20. It is desirable that the second mounting member 18 undergoes diameter reduction machining after the vulcanization molding of the main body rubber elastomer 20 and that the main body rubber elastomer 20 is pre-compressed. Thereby, tensile stress in the main body rubber elastomer 20 caused by thermal shrinkage after molding may be reduced.

The main body rubber elastomer 20 includes a concave part 28 opening at a lower surface. The concave part 28 is of an inverted mortar shape that widens downward. On the main body rubber elastomer 20, a first seal rubber layer 30 is integrally formed extending downward from an outer peripheral side of the concave part 28. The first seal rubber layer 30 is of a tubular shape having a small thickness and a large diameter, and covers an inner peripheral surface of a lower part of the second mounting member 18 over the entire circumference. The first seal rubber layer 30 has a lower end surface firmly fixed to an upper surface of the inner flange 26. A radial thickness dimension of the first seal rubber layer 30 is smaller than a protrusion dimension of the inner flange 26 of the second mounting member 18 toward the inner periphery at least at a lower end. Accordingly, the inner flange 26 protrudes toward the inner periphery beyond the lower end of the first seal rubber layer 30.

On the second mounting member 18, a partition member 32 is mounted. The partition member 32 is of an overall substantially disk shape, and includes a first member 34 constituting an upper part and a second member 36 constituting a lower part.

The first member 34 includes a first concave part 38 that opens upward in an inner peripheral portion. In an outer peripheral portion of the first member 34, a first peripheral groove 40 is formed extending in a circumferential direction while opening at an outer peripheral surface. The first peripheral groove 40 communicates with the first concave part 38 through an upper communication opening (not shown) that opens at a peripheral wall of the first concave part 38.

The second member 36 is of a substantially disk shape having a larger thickness than the first member 34, and includes a second concave part 42 that opens downward in an inner peripheral portion. In an upper part of the second member 36, a second upper peripheral groove 44 is formed extending in the circumferential direction while opening at an upper surface. In a lower part of the second member 36, a second lower peripheral groove 46 is formed extending in the circumferential direction while opening at an outer peripheral surface. The second upper peripheral groove 44 and the second lower peripheral groove 46 are serially communicated through a communication hole 48 at a portion in the circumferential direction. The second lower peripheral groove 46 communicates with the second concave part 42 through a lower communication opening (not shown) that opens at a peripheral wall of the second concave part 42.

On an outer peripheral surface of the second member 36, an upper locking groove 50 and a lower locking groove 52 are formed open. The upper locking groove 50 and the lower locking groove 52 open at the outer peripheral surface of the second member 36 at a position above the second lower peripheral groove 46, and are continuously formed over the entire circumference.

The first member 34 and the second member 36 overlap each other in the up-down direction. For example, a pin-shaped connecting part 54 protruding from the upper surface of the second member 36 is inserted through, caulked and fixed to a connecting hole 56 formed through a bottom wall of the first concave part 38 of the first member 34, or the like, and the first member 34 and the second member 36 are fixed to each other.

In a state in which the first member 34 and the second member 36 are connected and fixed to each other, the first peripheral groove 40 of the first member 34 and the second upper peripheral groove 44 of the second member 36 communicate with each other through a communication hole (not shown).

The partition member 32 is inserted from below into the inner periphery of the second mounting member 18. By diameter reduction machining of the second mounting member 18, the second mounting member 18 is pressed against an outer peripheral surface of the partition member 32 via the first seal rubber layer 30, thereby mounting the partition member 32 on the second mounting member 18. Accordingly, the space between the inner peripheral surface of the second mounting member 18 and the outer peripheral surface of the partition member 32 is liquid-tightly sealed by the first seal rubber layer 30.

By the diameter reduction machining of the second mounting member 18, the inner flange 26 of the second mounting member 18 is inserted into the upper locking groove 50 that opens at the outer peripheral surface of the second member 36, and the partition member 32 is positioned in the up-down direction with respect to the second mounting member 18. A portion of the partition member 32 below the upper locking groove 50 protrudes downward from the second mounting member 18. The second mounting member 18 is fitted to the outer peripheral surface of the partition member 32 by having an axial lower part into which the partition member 32 is inserted subjected to diameter reduction machining, and the axial lower part has a slightly smaller diameter than an axial upper part.

A flexible film 58 is mounted on the partition member 32. The flexible film 58 is made of rubber or resin elastomer, is of a substantially disk shape having a small thickness and a large diameter, and is allowed to undergo bending deformation in a thickness direction. The flexible film 58 is also allowed to expand and contract to some extent. A fixing member 60 is firmly fixed to an outer peripheral end of the flexible film 58. The fixing member 60 is tubular or annular, and has an upper end provided with a locking protruding piece 62 protruding toward the inner periphery. An inner peripheral surface of the fixing member 60 is covered with a second seal rubber layer 64 integrally formed with the flexible film 58. A thickness dimension of the second seal rubber layer 64 is smaller than a protrusion dimension of the locking protruding piece 62 at least at the upper end, and the locking protruding piece 62 protrudes further toward the inner peripheral side than the second seal rubber layer 64. By subjecting the fixing member 60 to diameter reduction machining while the fixing member 60 is externally inserted into the lower part of the partition member 32, the inner peripheral surface of the fixing member 60 is liquid-tightly fitted to the outer peripheral surface of the partition member 32 via the second seal rubber layer 64. By the diameter reduction machining of the fixing member 60, the locking protruding piece 62 of the fixing member 60 is inserted into the lower locking groove 52 of the partition member 32, and the fixing member 60 is positioned in the up-down direction with respect to the partition member 32. Accordingly, the fixing member 60 is fixed to the partition member 32, and the flexible film 58 is mounted on the second mounting member 18 via the partition member 32.

Above the partition member 32, a pressure receiving chamber 66 is formed in which a wall is composed of the main body rubber elastomer 20. A non-compressible fluid is sealed in the pressure receiving chamber 66, and internal pressure fluctuation is caused by deformation of the main body rubber elastomer 20. Below the partition member 32, an equilibrium chamber 68 is formed in which a wall is composed of the flexible film 58. A non-compressible fluid is sealed in the equilibrium chamber 68, and volume change is allowed by deformation of the flexible film 58. The non-compressible fluid sealed in the pressure receiving chamber 66 and the equilibrium chamber 68 is preferably a low-viscosity liquid. For example, water, ethylene glycol, alkylene glycol, silicone oil, or a mixture thereof may be adopted.

The pressure receiving chamber 66 and the equilibrium chamber 68 are in communication with each other through an orifice passage 70 as a fluid passage composed of the first peripheral groove 40, the second upper peripheral groove 44, and the second lower peripheral groove 46. That is, an outer peripheral opening of the first peripheral groove 40 is liquid-tightly covered by the second mounting member 18, an outer peripheral opening of the second lower peripheral groove 46 is liquid-tightly covered by the fixing member 60 of the flexible film 58, and an upper opening of the second upper peripheral groove 44 is further covered by the first member 34, thereby forming the orifice passage 70 that communicates the pressure receiving chamber 66 and the equilibrium chamber 68 with each other. A tuning frequency being a resonance frequency of a fluid flowing inside the orifice passage 70 is adjusted according to a ratio between the passage cross-sectional area and the passage length, and is set to a frequency of a vibration damping target vibration. For example, the tuning frequency is set to approximately 10 Hz corresponding to engine shake.

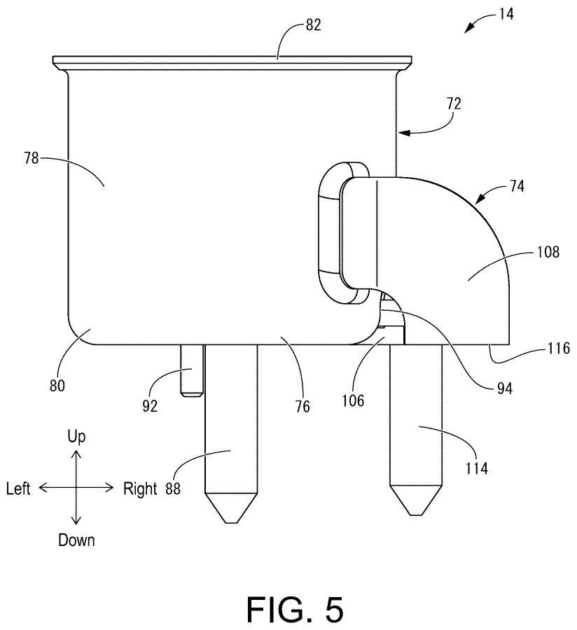

The mounting bracket 14 is mounted on the mount body 12. As also shown in FIG. 5 to FIG. 8, the mounting bracket 14 includes a mounting bracket 72 of a cup shape, and a bracket leg 74 fixed to the mounting bracket 72.

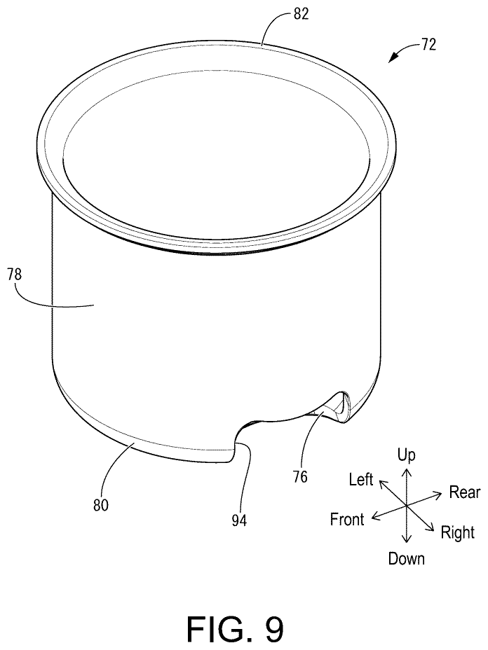

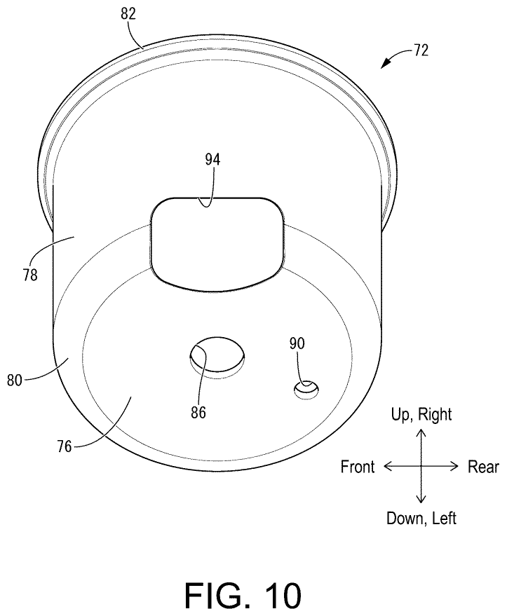

As also shown in FIG. 9 and FIG. 10, the mounting bracket 72 is made of metal such as iron or aluminum alloy, and is of a substantially bottomed cylindrical shape integrally including a bottom wall 76 of a substantially disk shape and a peripheral wall 78 of a substantially cylindrical shape. As shown in FIG. 4, the bottom wall 76 and the peripheral wall 78 are smoothly continuous through an outer peripheral corner 80 that curves in an arc shape in a vertical cross-section. At an upper end of the mounting bracket 72, a flange-like part 82 protruding to an outer periphery is provided over the entire circumference. In the flange-like part 82 of the present embodiment, an outer peripheral surface of an upper part has a substantially constant outer diameter dimension, and a lower part has an outer peripheral surface of a tapered shape increasing in diameter upward.

A reinforcement plate 84 overlaps an upper surface of the bottom wall 76 of the mounting bracket 72. The reinforcement plate 84 is smaller than the bottom wall 76 and partially covers the bottom wall 76. The reinforcement plate 84 of the present embodiment is of a substantially disk shape. However, the shape of the reinforcement plate 84 is not particularly limited. The reinforcement plate 84 is arranged around an inner fixing bolt 88 to be described later, and is located away from a positioning pin 92 to be described later. The reinforcement plate 84 is firmly fixed to the bottom wall 76 by, for example, being welded to the bottom wall 76 at multiple positions in the circumferential direction.

As shown in FIG. 10, an inner bolt insertion hole 86 penetrating in the up-down direction is formed in the bottom wall 76 of the mounting bracket 72 and the reinforcement plate 84. As shown in FIG. 5 to FIG. 8, the inner fixing bolt 88 is inserted through the inner bolt insertion hole 86 from above, and an upper end portion of a shaft part of the inner fixing bolt 88 is fitted and fixed in the inner bolt insertion hole 86.

As shown in FIG. 10, a pin insertion hole 90 penetrating in the up-down direction is formed in the bottom wall 76 of the mounting bracket 72. The pin insertion hole 90 is formed in a portion outside the inner bolt insertion hole 86. As shown in FIG. 4 to FIG. 8, the positioning pin 92 is inserted through the pin insertion hole 90 from above, and an upper end portion of a shaft part of the positioning pin 92 is fitted and fixed in the pin insertion hole 90.

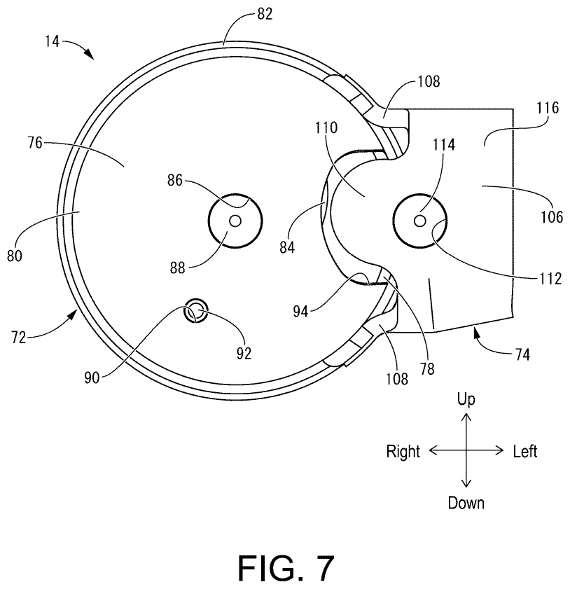

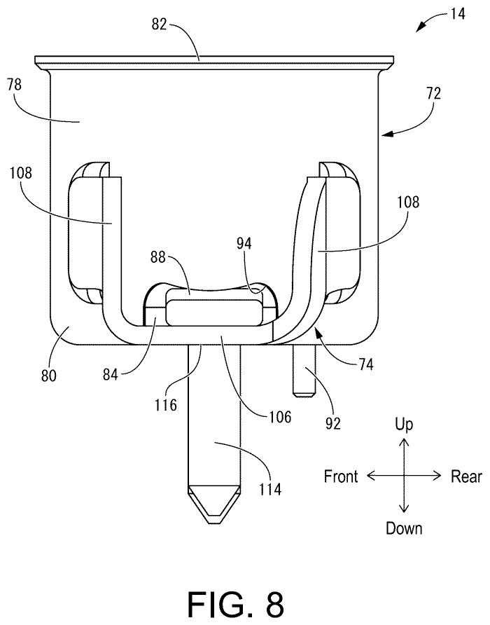

As shown in FIG. 9 and FIG. 10, an outer punched window 94 as a notch window is formed in a portion of the mounting bracket 72 in the circumferential direction. The outer punched window 94 is formed to penetrate the mounting bracket 72 at the outer peripheral corner 80, and is formed in a region including the outer peripheral corner 80 that extends across both the bottom wall 76 and the peripheral wall 78. In the side view shown in FIG. 8, the outer punched window 94 is of an overall substantially rounded square shape, is of a substantially symmetrical shape with respect to the front-rear center, has an upper edge portion curved in a wavy manner, and has a front-rear central portion with an up-down dimension smaller than that of both front and rear end portions. In the bottom view shown in FIG. 7, the outer punched window 94 is of an overall substantially rounded square shape, is of a substantially symmetrical shape with respect to the front-rear center, has a left edge portion curved in an arc shape, and has the front-rear central portion with a left-right dimension larger than that of both front and rear end portions. In this way, in the present embodiment, an opening shape of the outer punched window 94 is a continuous curved shape without corners over the entire circumference.

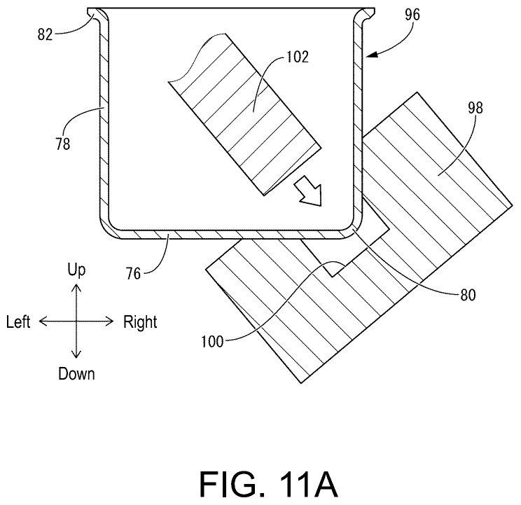

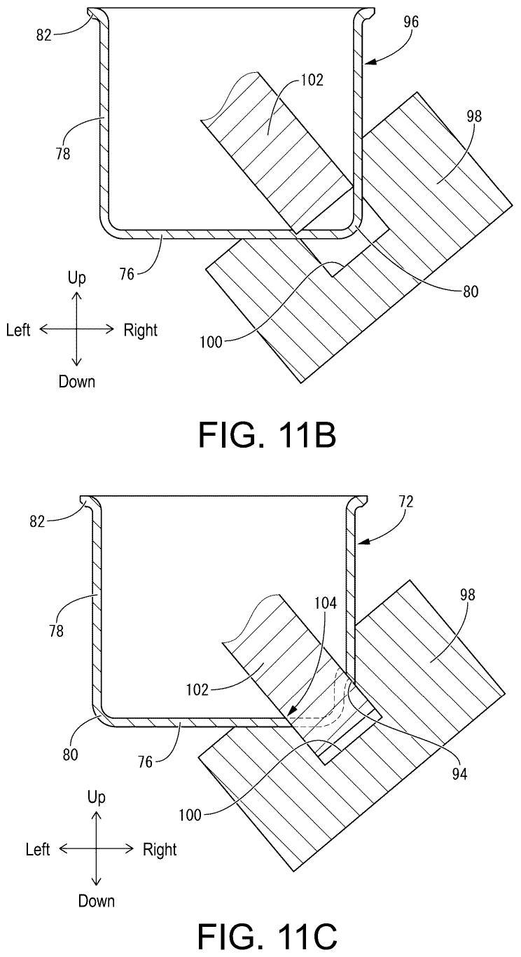

The outer punched window 94 of the mounting bracket 72 as described above is formed by a punching process as shown in FIG. 11A to FIG. 11C. That is, first, as shown in FIG. 11A, a cup fitting 96 of a bottomed cylindrical shape is prepared, and a portion of the outer peripheral corner 80 of the cup fitting 96 is set in a recess 100 of a die 98 for positioning. By inserting the outer peripheral corner 80 into the recess 100, a lower surface of the bottom wall 76 and an outer peripheral surface of the peripheral wall 78 overlap an inner surface of the recess 100 of the die 98. The recess 100 of the die 98 opens obliquely toward above the inner periphery.

Next, a punch 102 is inserted into the inside of the cup fitting 96 and arranged to face the recess 100 of the die 98 via the cup fitting 96. With a tip at a position corresponding to the recess 100 of the die 98, the punch 102 is obliquely inserted into the inner periphery of the cup fitting 96 toward the outer peripheral corner 80 of the cup fitting 96. The punch 102 has a shape, size, and insertion angle that allow its insertion into an upper opening of the cup fitting 96 without interfering with the peripheral wall 78. A punching direction by the punch 102 can be set considering the height of the peripheral wall 78 or the like and is not limited. However, considering the fact that the flexible film 58 expands and contacts from above in addition to the workability, it is desirable that, for example, an inclination angle in the punching direction is 40 to 60 degrees with respect to a bottom wall surface. More preferably, a corner between the bottom wall 76 and the peripheral wall 78 is arranged to be punched last.

The punch 102 is moved in a right obliquely downward direction to approach the die 98 located on the opposite side across the cup fitting 96. As shown in FIG. 11B, the punch 102 that has approached the die 98 makes preferential contact with its both side edges on an inner surface of the cup fitting 96 at a position separated from the outer peripheral corner 80 toward the bottom wall 76 side and the peripheral wall 78 side.

Next, by moving the punch 102 to further approach the die 98, as shown in FIG. 11C, a portion including the outer peripheral corner 80 of the cup fitting 96 is punched in an oblique direction from the inside to the outside by the punch 102. Accordingly, punching in an oblique direction from the inside to the outside is applied to the outer peripheral corner 80 of the cup fitting 96, the outer punched window 94 of a notch shape that partially opens in the circumferential direction is formed, and the mounting bracket 72 is formed including the outer punched window 94. In this way, by performing punching in an oblique direction only once on the cup fitting 96, the mounting bracket 72 including the outer punched window 94 that extends across the bottom wall 76 and the peripheral wall 78 can be easily obtained.

Since the outer punched window 94 is formed by being punched from the inside to the outside by the punch 102, burrs at an opening edge of the outer punched window 94 are formed to protrude outward. An inner opening edge 104 of the outer punched window 94 is simply chamfered by an edge being crushed by sliding contact of the punch 102 or the like, and at least the occurrence of burr-like protrusions that protrude inward from the inner surface of the cup fitting 96 can be prevented.

The punch 102 is brought into contact with the inner surface of the cup fitting 96 first at both side edges separated from the outer peripheral corner 80 toward the bottom wall 76 side and the peripheral wall 78 side, and both side edges away from the outer peripheral corner 80 are punched first. Accordingly, compared to the case where the outer peripheral corner 80 is preferentially punched, deformation of the cup fitting 96 caused by pressing of the punch 102 can be suppressed, and the outer punched window 94 can be formed with high shape accuracy by punching in an oblique direction.

After the formation (punching) of the outer punched window 94 by the punch 102 and the die 98 is completed, the punch 102 and the die 98 are removed from the mounting bracket 72. The mounting bracket 72 from which the punch 102 and the die 98 have been removed may be subjected to chamfering such as coining or cutting on the inner opening edge 104 of the outer punched window 94. In this case as well, the formation of burrs at the inner opening edge 104 of the outer punched window 94 can be suppressed, and the inner opening edge 104 can be simply chamfered during punching, thereby facilitating post-processing such as chamfering.

The inner bolt insertion hole 86 and the pin insertion hole 90 provided in the mounting bracket 72 may be formed in advance before the formation of the outer punched window 94, or may be formed after the formation of the outer punched window 94. The inner bolt insertion hole 86 and the pin insertion hole 90 are formed, for example, by punching. In that case, it is desirable that the inner bolt insertion hole 86 and the pin insertion hole 90 are formed by punching from the inside (upper side) to the outside (lower side) of the bottom wall 76.

The bracket leg 74 is mounted on the mounting bracket 72. The bracket leg 74 is of an overall groove shape extending in the left-right direction, and integrally includes a mounting plate 106 constituting a groove bottom and a pair of fixing plates 108, 108.

The mounting plate 106 extends in an axis-perpendicular direction (up-down perpendicular direction). As shown in FIG. 7, the mounting plate 106 includes an insertion part 110 of a substantially half-disk shape that protrudes toward the left at the front-rear central portion. An outer bolt insertion hole 112 penetrating in the up-down direction is formed to the right of the insertion part 110 in the mounting plate 106. An outer fixing bolt 114 is inserted through the outer bolt insertion hole 112 from above. As shown in FIG. 4, an upper end portion of a shaft part of the outer fixing bolt 114 is fitted and fixed in the outer bolt insertion hole 112. In a fixed state of the bracket leg 74 to the mounting bracket 72 to be described later, the inner fixing bolt 88 and the outer fixing bolt 114 may be arranged at different positions from each other or may be arranged at the same position as each other in the front-rear direction.

The pair of fixing plates 108, 108 protrude upward from both front and rear ends of the mounting plate 106. As shown in FIG. 5, in a projection in the front-rear direction, the pair of fixing plates 108, 108 have a curved arc shape that slopes downward toward the right. In the fixing plates 108, 108 of the bracket leg 74, a lower end of a right end is continuous with the mounting plate 106. The bracket leg 74 is, for example, a press fitting that integrally includes the mounting plate 106 and the fixing plates 108, 108, in which the fixing plates 108, 108 are formed by bending on both front and rear sides of the mounting plate 106.

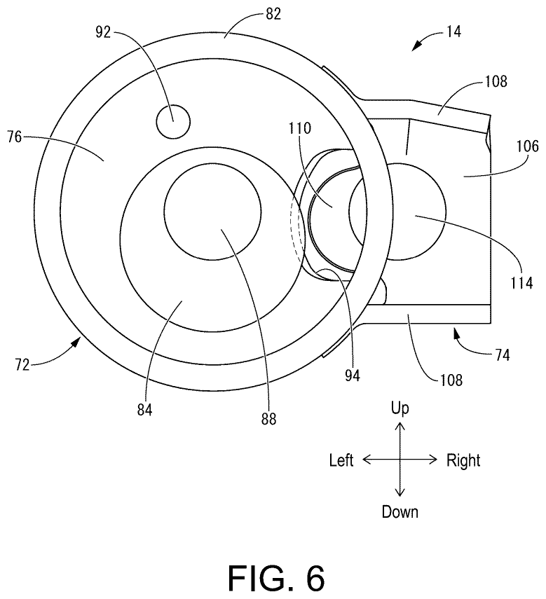

As shown in FIG. 4, FIG. 6, and FIG. 7, the insertion part 110 of the mounting plate 106 in the bracket leg 74 is inserted from the outside (right side) to the inside (left side) of the mounting bracket 72 through the outer punched window 94. A portion of the mounting plate 106 to the right of the insertion part 110 extends out to the right of the outer punched window 94. The mounting plate 106 is arranged to be separated from and not in contact with an opening periphery of the outer punched window 94. A lower surface of the mounting plate 106 is taken as a mounting surface 116 that extends in the same plane as the lower surface of the bottom wall 76 of the mounting bracket 72.

Since the mounting plate 106 enters inside the mounting bracket 72 through the outer punched window 94, as shown in FIG. 4 and FIG. 6, the outer fixing bolt 114 fixed to the mounting plate 106 has at least a portion of a head arranged within the outer punched window 94, and overlaps the peripheral wall 78 in a projection in the up-down direction. The outer fixing bolt 114 has the head separated downward from the peripheral wall 78 and is provided without interfering with the peripheral wall 78. In this way, since the outer punched window 94 is provided in the mounting bracket 72, and the mounting plate 106 on which the outer fixing bolt 114 is mounted is inserted into the outer punched window 94, it is possible to arrange the outer fixing bolt 114 on a downward extension of the peripheral wall 78 of the mounting bracket 72. Accordingly, the degree of freedom in arranging the outer fixing bolt 114 is increased. In the present embodiment, a portion of the inner bolt insertion hole 86 formed in the mounting plate 106 overlaps the peripheral wall 78 in a projection in an axial direction, and the shaft part of the inner fixing bolt 88 is also arranged at a position overlapping the peripheral wall 78 in the axial direction.

The pair of fixing plates 108, 108 of the bracket leg 74 have a left end fixed to the outer peripheral surface of the peripheral wall 78 of the mounting bracket 72 by means such as welding. Accordingly, the mounting plate 106 is firmly fixed to the mounting bracket 72 via the fixing plates 108, 108. As shown in FIG. 7, the left ends of the pair of fixing plates 108, 108 are formed in a tapered shape that slopes outward, separating from each other in the front-rear direction toward the left, and overlap along the outer peripheral surface of the peripheral wall 78 of the mounting bracket 72.

The bracket leg 74 is prepared in a predetermined shape including the mounting plate 106 and the fixing plates 108, 108 by press working, and is firmly fixed to the mounting bracket 72 formed through the above-mentioned punching process of the outer punched window 94 by the following fixing process of the bracket leg 74 to the mounting bracket 72. That is, first, the bracket leg 74 is positioned in the circumferential direction with respect to a portion where the outer punched window 94 is formed in the mounting bracket 72. By bringing the bracket leg 74 close to the outer punched window 94, the insertion part 110 of the mounting plate 106 enters from the outside to the inside of the mounting bracket 72 through the outer punched window 94, and the left ends of the fixing plates 108, 108 overlap the outer peripheral surface of the mounting bracket 72 on both sides in the circumferential direction outside the outer punched window 94. By welding the mounting bracket 72 and the fixing plates 108, 108, the bracket leg 74 is fixed to the mounting bracket 72 with the mounting plate 106 entering inside the mounting bracket 72. By completing such a fixing process between the mounting bracket 72 and the bracket leg 74, the mounting bracket 14 is formed.

The mounting bracket 14 of such a structure is fixed to the second mounting member 18 of the mount body 12. That is, as shown in FIG. 4, an upper part of the second mounting member 18 is press-fitted into the mounting bracket 72 of the mounting bracket 14, thereby fixing the mounting bracket 14 to the second mounting member 18 and constituting the engine mount 10. The flange-like part 82 provided at the upper end of the mounting bracket 72 of the mounting bracket 14 abuts against and overlaps the outer flange 24 provided at an upper end of the second mounting member 18 from below, thereby defining a relative position in the axial direction of the mounting bracket 14 with respect to the second mounting member 18.

In the mounting bracket 72 fixed to the second mounting member 18, the peripheral wall 78 is arranged to surround an outer peripheral side of the flexible film 58, and the bottom wall 76 is arranged separated below the flexible film 58 and covers below the flexible film 58.

In the engine mount 10, the first mounting member 16 is mounted on a power unit (not shown) via, and the second mounting member 18 is mounted on a vehicle body 118 as a vibration damping target member via the mounting bracket 14. Accordingly, the power unit and the vehicle body 118 are connected in a vibration damping manner via the engine mount 10, and the engine mount 10 is installed in the vehicle.

In the mounting bracket 72 of the mounting bracket 14, the lower surface of the bottom wall 76 overlaps in contact with the vehicle body 118. In the bracket leg 74 of the mounting bracket 14, the mounting surface 116 being the lower surface of the bracket leg 74 extends in the same plane as the lower surface of the bottom wall 76 of the mounting bracket 72, and the mounting surface 116 of the bracket leg 74 also overlaps in contact with the vehicle body 118. In this way, since the lower surface of the bottom wall 76 of the mounting bracket 72 and the lower surface (mounting surface 116) of the bracket leg 74 are located in the same plane and each overlap the vehicle body 118, a large contact area with the vehicle body 118 is secured and a mounting state to the vehicle body 118 is stabilized.

The mounting bracket 72 of the mounting bracket 14 is fixed to the vehicle body 118 by the inner fixing bolt 88 and the outer fixing bolt 114 while being positioned by the positioning pin 92. The inner fixing bolt 88 is provided in a portion where the bottom wall 76 of the mounting bracket 72 and the reinforcement plate 84 overlap. Since deformation rigidity at a mounting portion of the inner fixing bolt 88 is increased, deformation of the mounting bracket 14 is prevented even if a large external force acts on the mounting portion of the inner fixing bolt 88. Since the fastening to the vehicle body 118 is performed not only by the inner fixing bolt 88 but also by the outer fixing bolt 114, load bearing performance may be improved by dispersing the input. The mounting plate 106 where the outer fixing bolt 114 is provided is larger in thickness than the bottom wall 76 of the mounting bracket 72, and is increased in deformation rigidity.

In a state in which the engine mount 10 is installed in the vehicle, when the vibration damping target vibration is input between the first mounting member 16 and the second mounting member 18, the internal pressure of the pressure receiving chamber 66 fluctuates due to elastic deformation of the main body rubber elastomer 20, and a relative pressure difference occurs between the pressure receiving chamber 66 and the equilibrium chamber 68. Due to this pressure difference, fluid flow occurs in the orifice passage 70 that communicates the pressure receiving chamber 66 and the equilibrium chamber 68 with each other, and a vibration damping effect due to the fluid flow action is exhibited. In the present embodiment, during vibration input corresponding to engine shake, a vibration damping effect based on a high damping action of the orifice passage 70 is exhibited.

As fluid flows between the pressure receiving chamber 66 and the equilibrium chamber 68, the flexible film 58 constituting a wall of the equilibrium chamber 68 is deformed to suppress pressure fluctuations within the equilibrium chamber 68. Accordingly, if the fluid inside the pressure receiving chamber 66 flows into the equilibrium chamber 68, the flexible film 58 is deformed to bulge outward and approaches the bottom wall 76 and peripheral wall 78 of the mounting bracket 72. In this case, it is conceivable that the flexible film 58 may contact the inner opening edge 104 of the outer punched window 94 formed in the mounting bracket 72. The outer punched window 94 is formed by punching from the inside toward the outside, and burrs are less likely to be formed at the inner opening edge 104. Accordingly, even if the flexible film 58 contacts the inner opening edge 104 of the outer punched window 94, the flexible film 58 is less likely to be damaged. In order to relatively advantageously avoid damage due to contact with the flexible film 58, post-processing such as chamfering by coining or cutting may be applied to the inner opening edge 104 of the outer punched window 94. However, even in that case, since the formation of burrs during punching is suppressed, the post-processing such as chamfering is facilitated.

Although the embodiments of the present disclosure have been described in detail above, the present disclosure is not limited by the specific description thereof. For example, in the first embodiment, the mounting bracket 14 and the second mounting member 18 of the mount body 12 are fixed by press fitting. However, the method of fixing the mounting bracket 14 to the second mounting member 18 is not limited to press fitting. Specifically, for example, as shown in Japanese Patent Laid-Open No. 2007-182930, the flange-like part 82 provided at an upper end of the mounting bracket 72 may be caulked and fixed to the second mounting member.

The inner fixing bolt 88 may be omitted, and the mounting bracket 14 may be fixed to the vehicle body 118 only by the outer fixing bolt 114. Multiple outer fixing bolts 114 can be provided. In this case, multiple outer fixing bolts 114 may be provided on one bracket leg 74, or multiple outer fixing bolts 114 can also be provided by forming multiple outer punched windows 94 in the mounting bracket 72 and mounting multiple bracket legs 74 on the mounting bracket 72. If multiple outer fixing bolts 114 are provided, at least one outer fixing bolt 114 is arranged at a position that interferes with the peripheral wall 78 of the mounting bracket 72. Multiple inner fixing bolts 88 can also be provided.

The lower surface of the bottom wall 76 of the mounting bracket 72 and the lower surface of the mounting plate 106 of the bracket leg 74 may extend in different planes. According to this, it is possible to accommodate, for example, a case where there is a step on an upper surface of the vehicle body 118.

The reinforcement plate 84 is not essential. For example, in a case where an input load to the inner fixing bolt 88 is relatively small and the deformation rigidity of the bottom wall 76 of the mounting bracket 72 is not insufficient, the reinforcement plate 84 may be omitted. A reinforcement plate that receives input to the outer fixing bolt 114 may be provided so as to overlap the mounting plate 106. Furthermore, a common reinforcement plate that extends across both the bottom wall 76 of the mounting bracket 72 and the mounting plate 106 can also be adopted. It is also possible to improve strength or the like by integrating the bottom wall 76 of the mounting bracket 72 with the mounting plate 106 by welding or the like. In that case, by welding the common reinforcement plate that extends across both the bottom wall 76 and the mounting plate 106 to each of the bottom wall 76 and the mounting plate 106, the bottom wall 76 and the mounting plate 106 can be integrated via the reinforcement plate.

The partition member 32 does not necessarily have to be composed of multiple components combined together. For example, the entire partition member 32 may be composed of a single component. The partition member 32 may be provided with a conventionally known liquid pressure absorbing mechanism such as a movable plate or movable membrane. The fluid passage is not necessarily limited to one composed of three peripheral grooves 40, 44, and 46, like the orifice passage 70 shown in the first embodiment, and may be composed of one or two peripheral grooves, or may be composed of four or more peripheral grooves. The fluid passage is not limited to one that extends in the circumferential direction in an outer peripheral portion of a partition member, and can be, for example, in the shape of a hole that penetrates an inner peripheral portion of the partition member in the axial direction.

In the first embodiment, the vehicle body 118 is illustrated as an example of the

vibration damping target member on which the mounting bracket 14 is mounted. However, the vibration damping target member is not limited to the vehicle body 118, and may be, for example, a power unit or a subframe.

1. A fluid-filled vibration damping device, comprising:
a pressure receiving chamber, comprising a main body rubber elastomer in a wall, the main body rubber elastomer being elastically deformed upon receiving a vibration;
an equilibrium chamber, comprising a flexible film in a wall;
a fluid passage, communicating the pressure receiving chamber and the equilibrium chamber with each other;
a mounting bracket of a bottomed tubular shape, covering the flexible film;
a notch window, partially opening in a circumferential direction at an outer peripheral corner on a bottom wall side of the mounting bracket, comprising an outward punched window formed by punching from inside toward outside in an oblique direction in a region extending across both the bottom wall and a peripheral wall of the mounting bracket;
a bracket leg, firmly fixed to the mounting bracket, provided with a mounting plate that enters from outside to inside of the mounting bracket through the outward punched window of the mounting bracket; and
an outer fixing bolt, for fixing the mounting bracket to a vibration damping target member, mounted on the mounting plate and located within the outward punched window.

2. The fluid-filled vibration damping device according to claim 1, wherein
a lower surface of the mounting plate is formed with a mounting surface that extends in a same plane as an outer surface of the bottom wall of the mounting bracket.

3. The fluid-filled vibration damping device according to claim 1, wherein
a reinforcement plate overlaps from an inner surface and is firmly fixed to the bottom wall of the mounting bracket, and an inner fixing bolt for fixing the mounting bracket to the vibration damping target member is provided penetrating the reinforcement plate and the bottom wall.

4. The fluid-filled vibration damping device according to claim 1, wherein
the outward punched window is of an opening shape that curves smoothly without corners in a projection in a punching direction.

5. A manufacturing method of a fluid-filled vibration damping device, in which the fluid-filled vibration damping device comprises a pressure receiving chamber that comprises a main body rubber elastomer in a wall, the main body rubber elastomer being elastically deformed upon receiving a vibration, an equilibrium chamber that comprises a flexible film in a wall, a fluid passage that communicates the pressure receiving chamber and the equilibrium chamber with each other, and a mounting bracket of a bottomed tubular shape that covers the flexible film, wherein the manufacturing method comprises following processes in manufacturing the fluid-filled vibration damping device:
by performing punching from inside toward outside in an oblique direction on an outer peripheral corner on a bottom wall side extending across both the bottom wall and a peripheral wall of the mounting bracket, forming an outward punched window of a notch shape that partially opens in a circumferential direction at the outer peripheral corner of the mounting bracket; and
firmly fixing a bracket leg to the mounting bracket, the bracket leg comprising a mounting plate that enters from outside to inside of the mounting bracket through the outward punched window of the mounting bracket.

6. The manufacturing method of a fluid-filled vibration damping device according to claim 5, wherein
a punch for punching contacts and punches both side edges separated on the bottom wall side and the peripheral wall side of the mounting bracket in advance of contacting and punching the outer peripheral corner between the bottom wall and the peripheral wall of the mounting bracket.
